(19) United States
(12) Patent Application Publication
(10) Pub. No.: US 2014/0073882 A1
(43) Pub. Date: Mar. 13, 2014

(54) CLINICAL DIAGNOSIS OBJECTS AUTHORING

(71) Applicant: Consuli, Inc., San Diego, CA (US)

(72) Inventors: John Choi, Irvine, CA (US); Reza Ghanbari, San Diego, CA (US)

(73) Assignee: CONSULI, INC., San Diego, CA (US)

(21) Appl. No.: 14/025,735

(22) Filed: Sep. 12, 2013

Related U.S. Application Data
(60) Provisional application No. 61/700,309, filed on Sep. 12, 2012.
(60) Provisional application No. 61/719,766, filed on Oct. 29, 2012.

(51) Int. Cl. G06F 19/00

(52) U.S. Cl. CPC G06F 19/345
USPC 600/301

(57) ABSTRACT

A method for authoring clinical diagnosis data includes: parsing, on a processing device, clinical data regarding components and diagnoses of diseases, the components including at least one of signs, symptoms, or factors for generating structured clinical data; correlating, on the processing device, the structured clinical data based on at least one of the components; determining, on the processing device, clusters of the components that are related to the diseases; identifying, using principal component analysis on the processing device, one or more predictive components of the clusters of the components related to the diseases for generating a diagnosis predictive model; and generating, on the processing device, a disease model based on the diagnosis predictive model, the disease model being for diagnosing a patient in accordance with the identified one or more predictive components.

### CROSS-REFERENCE TO RELATED APPLICATIONS

This application claims the benefit of U.S. Provisional Patent Application No. 61/700,309, “CLINICAL DIAGNOSIS OBJECTS AUTHORING,” filed in the United States Patent and Trademark Office on Sep. 12, 2012, the entire disclosure of which is incorporated herein by reference and the benefit of U.S. Provisional Patent Application No. 61/719,766, “CLINICAL DIAGNOSIS OBJECTS INTERACTION,” filed in the United States Patent and Trademark Office on Oct. 29, 2012, the entire disclosure of which is incorporated herein by reference.

### FIELD

Aspects of embodiments of the present invention relate to systems for collecting and authoring medical diagnosis information, systems for diagnosing patients based on the medical diagnosis information, and methods of operating such systems.

### BACKGROUND

In the field of medical diagnosis, medical professionals such as doctors and nurses generally diagnose a patient's disease by conducting patient interviews, performing physical inspections, obtaining samples for chemical or biological analysis, and classifying the patient's symptoms into a disease based on the medical professional's knowledge and experience and in conjunction with medical reference materials.

Medical reference materials generally group diseases based on common characteristics. For example, all urinary tract infections may be grouped together. However, urinary tract infections have a wide variety of root causes and may have different presentations or symptoms based on the sex, age, and causes of the particular infection. As such, in many circumstances, standard medical reference materials do not provide sufficient granularity to provide a precise diagnosis of a patient's disease.

### SUMMARY

Embodiments of the present invention are related to a system and a method for collecting and authoring medical diagnosis information for performing precise determinations of patient diseases.

In an authoring phase, medical diagnosis information can be used to match symptoms presented by a patient to potential diagnoses. Broadly, this medical diagnosis information is generated by collecting and structuring clinical case data from a wide variety of patients, correlating the resulting diagnoses with the recorded symptoms to cluster related diseases together, and generating predictive models and disease models from the collected and analyzed data.

In a diagnosis phase, a medical practitioner can supply the symptoms presented by a patient to a computer system, in which the computer system utilizes the disease models to find the more likely matching disease for the supplied symptoms.

Embodiments of the present invention are directed to systems and methods related to the authoring and development of disease models from clinical data.

According to one embodiment of the present invention, a method for authoring clinical diagnosis data includes: parsing, on a processing device, clinical data regarding components and diagnoses of diseases, the components including at least one of signs, symptoms, and factors to generate structured clinical data; correlating, on the processing device, the structured clinical data by at least one of the components; determining, on the processing device, clusters of the components that are related to the diseases; identifying, on the processing device, one or more predictive components of the clusters of components related to the diseases to generate a diagnosis predictive model; and generating, on the processing device, a disease model using the diagnosis predictive model, the disease model being for diagnosing a patient in accordance with the identified one or more predictive components.

The parsing the clinical data may include: identifying a measurement associated with a symptom using semantic mapping; and extracting the identified measurement.

The measurement may include a temperature, a pulse rate, a blood pressure, or an O2 saturation.

The method may further include: displaying the structured clinical data in a user interface; receiving a request to modify the structured clinical data via the user interface; and modifying the structured clinical data in accordance with the request.

The method may further include: displaying the diagnosis predictive model in a user interface, the display including an indication of the strength of correlation between signs, symptoms, and factors; receiving a request to modify the diagnosis predictive model; and modifying the diagnosis predictive model in accordance with the modification.

The request may include one of adding, excluding, and locking in a sign, a symptom, or a factor.

The identifying one or more principal components may include performing principal component analysis on the structured data.

The method may further include displaying a diagnosis summary, wherein the diagnosis summary displays a frequency with which particular signs, symptoms, and factors are correlated with a diagnosis.

The method may further include computing, on the processing device, a symptoms ontology, the symptoms ontology relating symptoms and alternate phrasings to the same concept and mapping concepts to observed values.

According to one embodiment of the present invention, a system for authoring clinical diagnosis data may include a processing device including a processor and a memory storing instructions, the instructions configuring the processor to: parse clinical data regarding components and diagnoses of diseases, the components including at least one of signs, symptoms, and factors; correlate the clinical data by at least one of the components; determine clusters of the components that are related to the diseases; identify one or more predictive components of the clusters of components related to the diseases to generate a diagnosis predictive model; and generate a disease model from the diagnosis predictive model, the disease model being for diagnosing a patient in accordance with the identified one or more predictive components.

The instructions may configure the processor to parse clinical data by: identifying a measurement associated with a symptom using semantic mapping; and extracting the identified measurement.

The measurement may include a temperature, a pulse rate, a blood pressure, or an O2 saturation.

The instructions may further configure the processor to: display the structured clinical data in a user interface; receive a request to modify the structured clinical data via the user interface; and modify the structured clinical data in accordance with the request.

The instructions may further configure the processor to: display the diagnosis predictive model in a user interface, the display including an indication of the strength of correlation between signs, symptoms, and factors; receive a request to modify the diagnosis predictive model; and modify the diagnosis predictive model in accordance with the modification.

The request may include one of adding, excluding, and locking in a sign, a symptom, or a factor.

The instructions may further configure the processor to identify one or more principal components by performing principal component analysis on the structured data.

The instructions may further configure the processor to display a diagnosis summary, wherein the diagnosis summary displays a frequency with which particular signs, symptoms, and factors are correlated with a diagnosis.

The instructions may further configure the processor to compute a symptoms ontology, the symptoms ontology relating symptoms and alternate phrasings to the same concept and mapping concepts to observed values.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a system block diagram illustrating a system for implementing a clinical diagnosis objects authoring system according to one embodiment of the present invention.

FIG. 2A is a block diagram of a computing device according to an embodiment of the present invention.

FIG. 2B is a block diagram of a computing device according to an embodiment of the present invention.

FIG. 2C is a block diagram of a computing device according to an embodiment of the present invention.

FIG. 2D is a block diagram of a computing device according to an embodiment of the present invention.

FIG. 2E is a block diagram of a network environment including several computing devices according to an embodiment of the present invention.

FIG. 3A is a diagram illustrating a domain model for clinical diagnosis objects, including actors, objects, and a diagnosis lifecycle according to one embodiment of the present invention.

FIG. 3B is a schematic illustration of a screenshot of a typical form for entering data in an electronic medical record system.

FIG. 4 is a flowchart illustrating a method for processing patient data to generate disease models according to one embodiment of the present invention.

FIG. 5 is a schematic illustration of a screenshot of a structured clinical case history according to one embodiment of the present invention.

FIG. 6 is a schematic illustration of a screenshot of a clinical case summary according to one embodiment of the present invention.

FIG. 7 is a schematic illustration of a screenshot of an interface for viewing and editing a diagnosis summary according to one embodiment of the present invention.

FIG. 8 is a schematic illustration of a screenshot of an interface for viewing and editing a diagnosis predictive model according to one embodiment of the present invention.

FIG. 9 is a schematic illustration of a screenshot of an interface for viewing and editing a disease model according to one embodiment of the present invention.

FIG. 10 is a schematic illustration of a screenshot of an interface for viewing and editing symptoms ontology to one embodiment of the present invention.

FIG. 11 is a schematic illustration of a screenshot of an interface for viewing and editing a diagnosis dialog for diagnosing a patient according to one embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

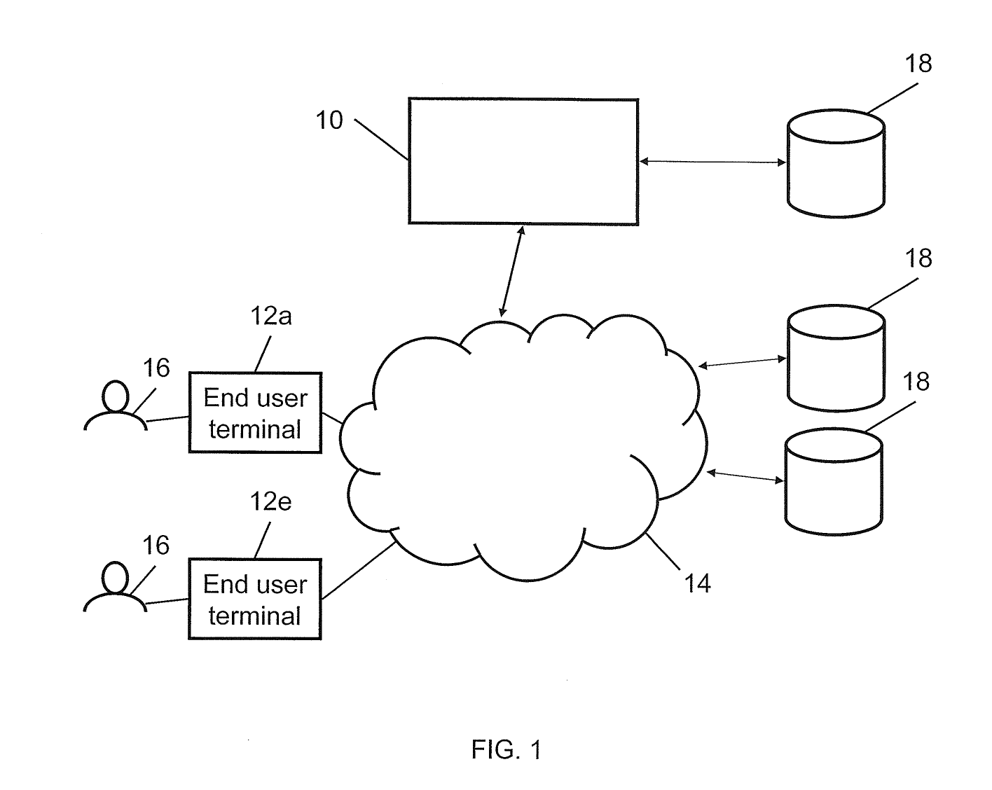

FIG. 1 is a system block diagram illustrating a system for implementing a clinical diagnosis objects authoring system according to one embodiment of the present invention. According to one embodiment of the present invention, the system may be implemented using an electronic database 18 (e.g., SQL databases such as MySQL®, PostgreSQL, and Microsoft® SQL Server® and NoSQL databases such as Apache Cassandra and MongoDB®) hosted on one or more database servers and the user interfaces may be provided via a web server 10 serving data to a web browser running on an end user terminal 12a using well known web technologies (e.g., serving pages written in HTML and JavaScript as served by web server software such as Apache, Microsoft® IIS, and Nginx™). The users 16 using the end user terminal 12a may include doctors, patients, system database editors, researchers, and other medical professionals who may contribute to the system or diagnose diseases using the information therein. The web browser may be connected to the web server over a network 14 such as, but not limited to, a private intranet, the public Internet, a virtual private network (VPN) connection, etc.

Various embodiments of the present invention can be performed on one or more computing devices (or “computers”), each of which includes one or more processors executing computer program instructions and interacting with other system components for performing the various functionalities described herein. For example, the web server 10, the electronic databases 18, and the end user terminals 12a and 12e may be various types of computing devices. For the sake of convenience herein, the term “computing device” will be used to refer to one or more such devices in which program instructions for performing various functions can be performed by a single device, by multiple devices performing the same functions in parallel, or by multiple devices in which some devices are configured to preform different functions from other devices.

The computer program instructions are stored in a memory implemented using a standard memory device, such as, for example, a random access memory (RAM). The computer program instructions may also be stored in other non-transitory computer readable media such as, for example, a CD-ROM, flash drive, or the like. Also, although the functionality of each of the servers is described as being provided by the particular server, a person of skill in the art should recognize that the functionality of various servers may be combined or integrated into a single server, or the functionality of a particular server may be distributed across one or more other servers without departing from the scope of the embodiments of the present invention.

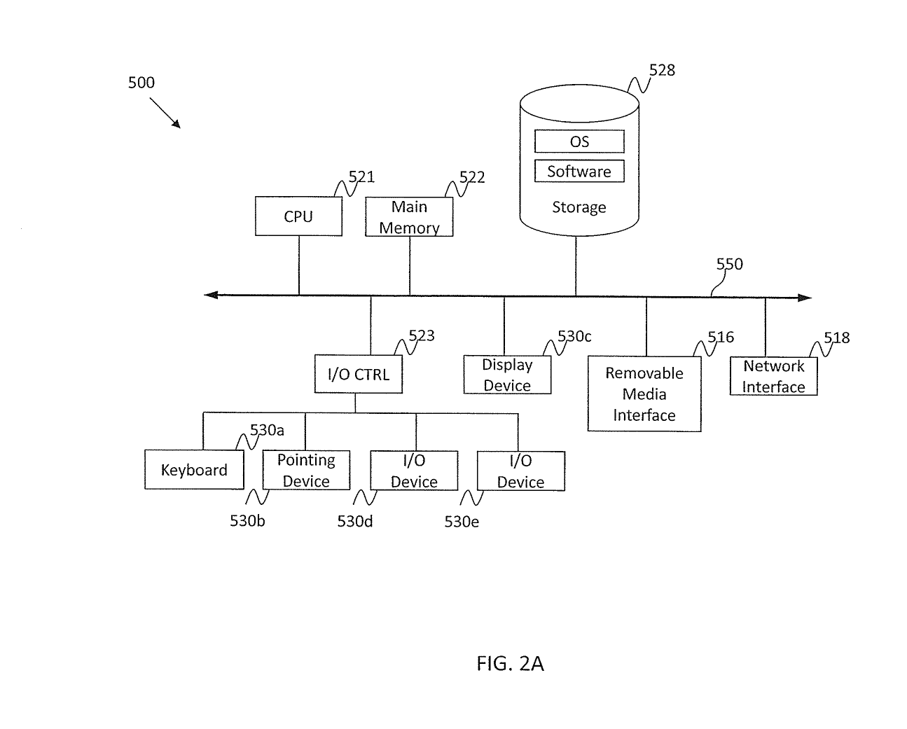

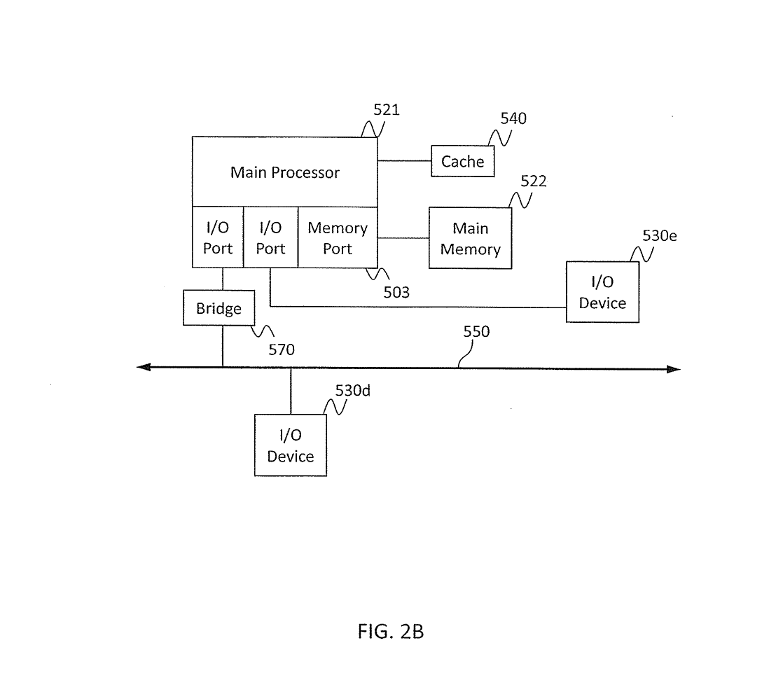

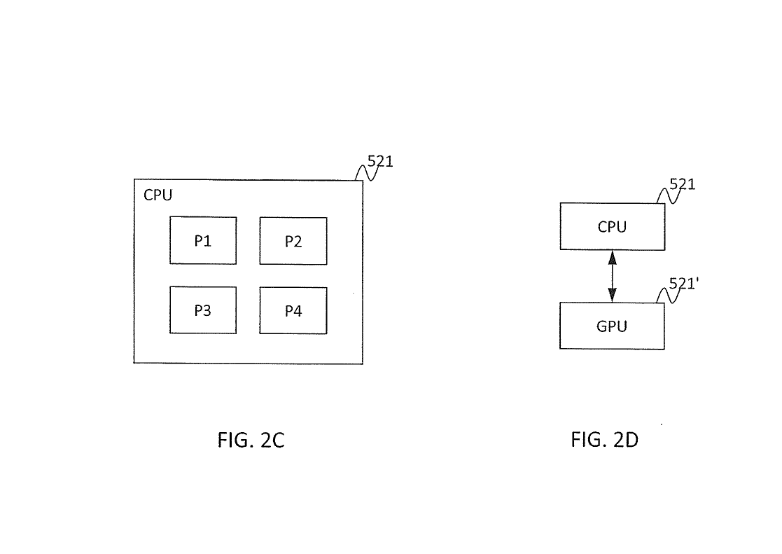

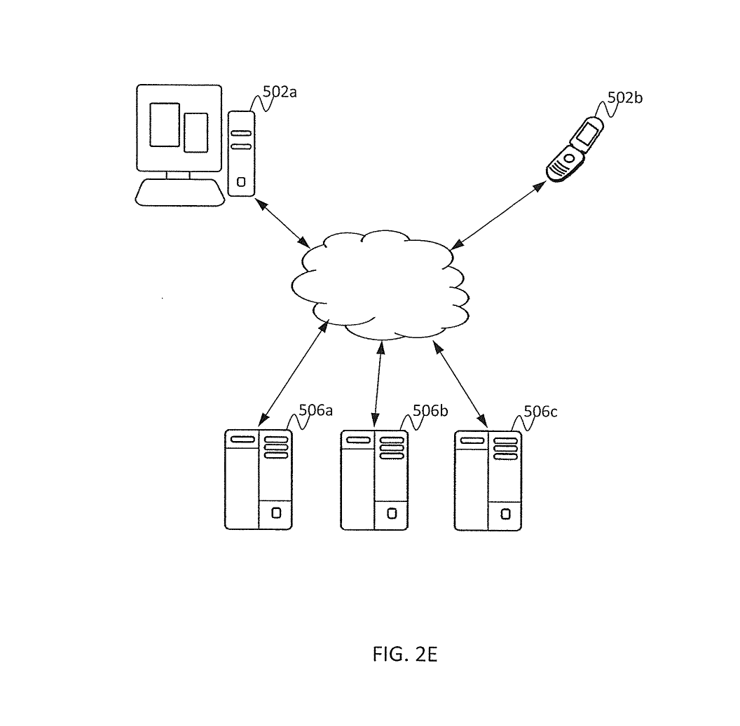

Each of the various servers in the system may be a process or thread, running on one or more processors, in one or more computing devices 500 (e.g., FIG. 2A, FIG. 2B), executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that a computing device may be implemented via firmware (e.g. an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the system may include servers and other modules.

FIG. 2A and FIG. 2B depict block diagrams of a computing device 500 as may be employed in exemplary embodiments of the present invention. As shown in FIG. 2A and FIG. 2B, each computing device 500 includes a central processing unit 521, and a main memory unit 522. As shown in FIG. 2A, a computing device 500 may include a storage device 528, a removable media interface 516, a network interface 518, an input/output (I/O) controller 523, one or more display devices 530c, a keyboard 530a and a pointing device 530b, such as a mouse. The storage device 528 may include, without limitation, storage for an operating system and software. As shown in FIG. 2B, each computing device 500 may also include additional optional elements, such as a memory port 503, a bridge 570, one or more additional input/output devices 530d, 530e and a cache memory 540 in communication with the central processing unit 521. Input/output devices, e.g., 530a, 530b, 530d, and 530e, may be referred to herein using reference numeral 530.

The central processing unit 521 is any logic circuitry that responds to and processes instructions fetched from the main memory unit 522. It may be implemented, for example, in an integrated circuit, in the form of a microprocessor, microcontroller, or graphics processing unit (GPU), or in a field-programmable gate array (FPGA) or application-specific integrated circuit (ASIC). Main memory unit 522 may be one or more memory chips capable of storing data and allowing any storage location to be directly accessed by the central processing unit 521. In the embodiment shown in FIG. 2A, the central processing unit 521 communicates with main memory 522 via a system bus 550. FIG. 2B depicts an embodiment of a computing device 500 in which the central processing unit 521 communicates directly with main memory 522 via a memory port 503.

FIG. 2B depicts an embodiment in which the central processing unit 521 communicates directly with cache memory 540 via a secondary bus, sometimes referred to as a backside bus. In other embodiments, the central processing unit 521 communicates with cache memory 540 using the system bus 550. Cache memory 540 typically has a faster response time than main memory 522. In the embodiment shown in FIG. 2A, the central processing unit 521 communicates with various I/O devices 530 via a local system bus 550. Various buses may be used as a local system bus 550, including a Video Electronics Standards Association (VESA) Local bus (VLB), an Industry Standard Architecture (ISA) bus, an Extended Industry Standard Architecture (EISA) bus, a MicroChannel Architecture (MCA) bus, a Peripheral Component Interconnect (PCI) bus, a PCI Extended (PCI-X) bus, a PCI-Express bus, or a NuBus. For embodiments in which an I/O device is a display device 530c, the central processing unit 521 may communicate with the display device 530c through an Advanced Graphics Port (AGP). FIG. 2B depicts an embodiment of a computer 500 in which the central processing unit 521 communicates directly with I/O device 530e. FIG. 2B also depicts an embodiment in which local busses and direct communication are mixed: the central processing unit 521 communicates with I/O device 530d using a local system bus 550 while communicating with I/O device 530e directly.

A wide variety of I/O devices 530 may be present in the computing device 500. Input devices include one or more keyboards 530a, mice, trackpads, trackballs, microphones, and drawing tablets. Output devices include video display devices 530c, speakers, and printers. An I/O controller 523, as shown in FIG. 2A, may control the I/O devices. The I/O controller may control one or more I/O devices such as a keyboard 530a and a pointing device 530b, e.g., a mouse or optical pen.

Referring again to FIG. 2A, the computing device 500 may support one or more removable media interfaces 516, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 530 may be a bridge between the system bus 550 and a removable media interface 516.

The removable media interface 516 may for example be used for installing software and programs. The computing device 500 may further include a storage device 528, such as one or more hard disk drives or hard disk drive arrays, for storing an operating system and other related software, and for storing application software programs. Optionally, a removable media interface 516 may also be used as the storage device. For example, the operating system and the software may be run from a bootable medium, for example, a bootable CD.

In some embodiments, the computing device 500 may include or be connected to multiple display devices 530c, which each may be of the same or different type and/or form. As such, any of the I/O devices 530 and/or the I/O controller 523 may include any type and/or form of suitable hardware, software, or combination of hardware and software to support, enable or provide for the connection to, and use of, multiple display devices 530c by the computing device 500. For example, the computing device 500 may include any type and/or form of video adapter, video card, driver, and/or library to interface, communicate, connect or otherwise use the display devices 530c. In one embodiment, a video adapter may include multiple connectors to interface to multiple display devices 530c. In other embodiments, the computing device 500 may include multiple video adapters, with each video adapter connected to one or more of the display devices 530c. In some embodiments, any portion of the operating system of the computing device 500 may be configured for using multiple display devices 530c. In other embodiments, one or more of the display devices 530c may be provided by one or more other computing devices, connected, for example, to the computing device 500 via a network. These embodiments may include any type of software designed and constructed to use the display device of another computing device as a second display device 530c for the computing device 500. One of ordinary skill in the art will recognize and appreciate the various ways and embodiments that a computing device 500 may be configured to have multiple display devices 530c.

A computing device 500 of the sort depicted in FIG. 2A and FIG. 2B may operate under the control of an operating system, which controls scheduling of tasks and access to system resources. The computing device 500 may be running any operating system, any embedded operating system, any real-time operating system, any open source operating system, any proprietary operating system, any operating systems for mobile computing devices, or any other operating system capable of running on the computing device and performing the operations described herein.

The computing device 500 may be any workstation, desktop computer, laptop or notebook computer, server machine, handheld computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 500 may be a virtualized computing device and the virtualized computing device may be running in a networked or cloud based environment. In some embodiments, the computing device 500 may have different processors, operating systems, and input devices consistent with the device.

In other embodiments the computing device 500 is a mobile device, such as a Java-enabled cellular telephone or personal digital assistant (PDA), a smart phone, a digital audio player, or a portable media player. In some embodiments, the computing device 500 includes a combination of devices, such as a mobile phone combined with a digital audio player or portable media player.

As shown in FIG. 2C, the central processing unit 521 may include multiple processors P1, P2, P3, P4, and may provide functionality for simultaneous execution of instructions or for simultaneous execution of one instruction on more than one piece of data. In some embodiments, the computing device 500 may include a parallel processor with one or more cores. In one of these embodiments, the computing device 500 is a shared memory parallel device, with multiple processors and/or multiple processor cores, accessing all available memory as a single global address space. In another of these embodiments, the computing device 500 is a distributed memory parallel device with multiple processors each accessing local memory only. In still another of these embodiments, the computing device 500 has both some memory which is shared and some memory which may only be accessed by particular processors or subsets of processors. In still even another of these embodiments, the central processing unit 521 includes a multicore microprocessor, which combines two or more independent processors into a single package, e.g., into a single integrated circuit (IC). In one exemplary embodiment, depicted in FIG. 2D, the computing device 500 includes at least one central processing unit 521 and at least one graphics processing unit 521′.

In some embodiments, a central processing unit 521 provides single instruction, multiple data (SIMD) functionality, e.g., execution of a single instruction simultaneously on multiple pieces of data. In other embodiments, several processors in the central processing unit 521 may provide functionality for execution of multiple instructions simultaneously on multiple pieces of data (MIMD). In still other embodiments, the central processing unit 521 may use any combination of SIMD and MIMD cores in a single device.

A computing device may be one of a plurality of machines connected by a network, or it may include a plurality of machines so connected. FIG. 2E shows an exemplary network environment. The network environment includes one or more local machines 502a, 502b (also generally referred to as local machine(s) 502, client(s) 502, client node(s) 502, client machine(s) 502, client computer(s) 502, client device(s) 502, endpoint(s) 502, or endpoint node(s) 502) in communication with one or more remote machines 506a, 506b, 506c (also generally referred to as server machine(s) 506 or remote machine(s) 506) via one or more networks 504. In some embodiments, a local machine 502 has the capacity to function as both a client node seeking access to resources provided by a server machine and as a server machine providing access to hosted resources for other clients 502a, 502b. Although only two clients 502 and three server machines 506 are illustrated in FIG. 2E, there may, in general, be an arbitrary number of each. The network 504 may be a local-area network (LAN), e.g., a private network such as a company Intranet, a metropolitan area network (MAN), or a wide area network (WAN), such as the Internet, or another public network, or a combination thereof.

The computing device 500 may include a network interface 518 to interface to the network 504 through a variety of connections including, but not limited to, standard telephone lines, local-area network (LAN), or wide area network (WAN) links, broadband connections, wireless connections, or a combination of any or all of the above. Connections may be established using a variety of communication protocols. In one embodiment, the computing device 500 communicates with other computing devices 500 via any type and/or form of gateway or tunneling protocol such as Secure Socket Layer (SSL) or Transport Layer Security (TLS). The network interface 518 may include a built-in network adapter, such as a network interface card, suitable for interfacing the computing device 500 to any type of network capable of communication and performing the operations described herein. An I/O device 530 may be a bridge between the system bus 550 and an external communication bus.

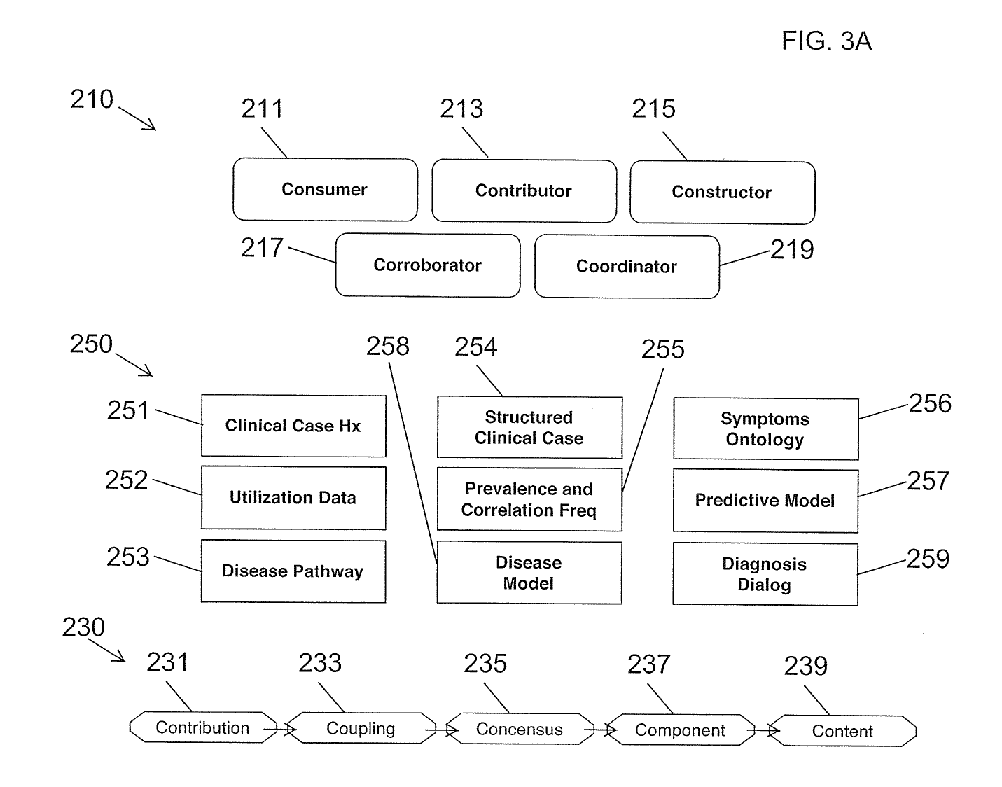

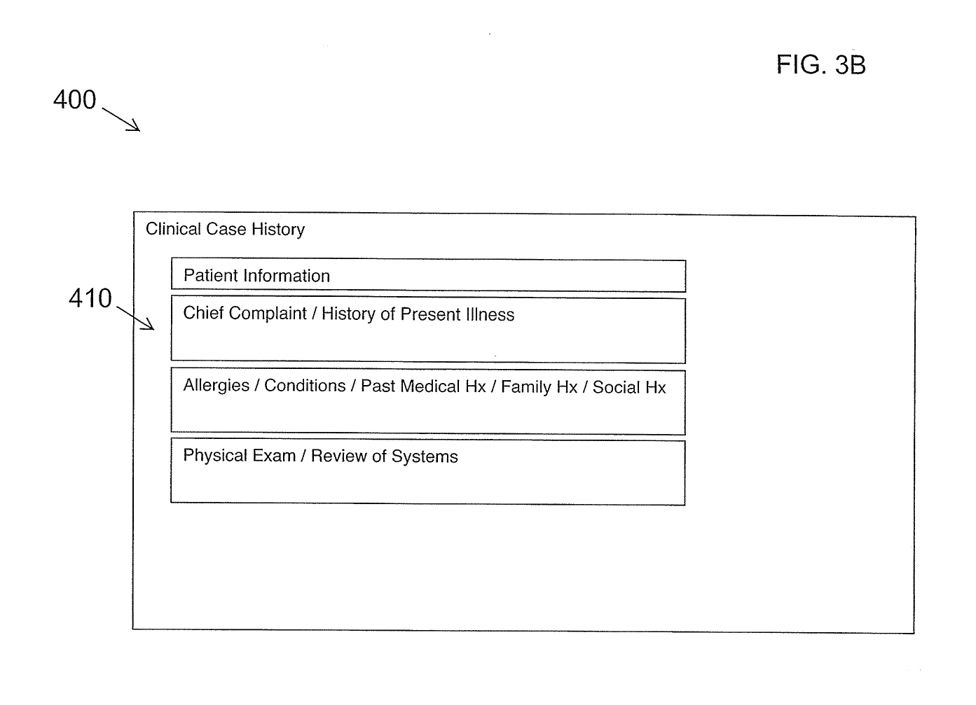

FIG. 3A is a diagram illustrating actors, objects, and lifecycle associated with developing clinical diagnosis objects according to one embodiment of the present invention. Generally, the development and use of clinical diagnosis tools involves multiple actors 210 including consumers 211, contributors 213, constructors 215, corroborators 217, and coordinators 219. The consumers 211 may include doctors and/or the general public, who make use of the diagnosis tools to determine which disease might currently afflict an individual. Contributors 213 may include medical professionals such as doctors, nurses, scientific researchers, academics, etc. who contribute data to the clinical diagnosis database. Constructors 215 include statisticians, academics, technical experts who may create components that are plugged into the system. Corroborators 217 review and comment on contributions and may lend credibility and evidence to corroborating the results. Coordinators 219 produce, facilitate, and moderate the socially produced content, and moderate the communications on the system.

Still referring to FIG. 3A, the lifecycle 230 of clinical diagnosis objects may include contribution, coupling, consensus, component, and content, which will be described in more detail below with reference to FIGS. 3-12. Briefly, data is collected (“contribution”) in operation 231 and aggregated by characteristics (“coupling”) in operation 233. Strong correlations may be determined (“consensus”) in operation 235 and weaker signals (e.g., signs which do not correlate to particular diseases) are given less weight, thereby isolating key predictive indicators of a disease (“component”) in operation 237. The resulting models of diseases may be presented to users (“content”) in operation 239 through, for example, a series of questions selected based on the components.

Still referring to FIG. 3A, various types of data objects 250 can be stored in the database 18 for use during the lifecycle 230 of the system. The data objects may include clinical case history (Hx) 251 as provided by clinical researchers or clinicians as entered into electronic medical record databases, utilization data 252 (e.g., information regarding the frequency with which particular patients make use of medical services), and disease pathways 253 as determined by scientists (e.g., as published in scientific and medical journals). Data may be contributed to the system from a variety of sources, including observation by medical professionals in a general clinical setting, clinical trials in a medical research setting, laboratory work from research academics and may include lists of symptoms, signs, lab results, past medical history, etc. alongside demographic information (e.g., age, sex, weight) about the patient, timing of the symptoms, disease pathways as determined by researchers, attempted treatments, clinical data regarding effectiveness of various drugs and dosing, etc.

In some circumstances, the clinical case history is entered as free form text. An exemplary case history entered as free form text is shown in Table 1.

TABLE 1
CHIEF COMPLAINT: Frequency and urgency and a growth on the labia.
HISTORY OF PRESENT ILLNESS: This (XX)-year-old female presents to the emergency room
with complaints of 3 days of increased frequency, urgency and dysuria. The patient states she has
had a history of urinary tract infections in the past and she knows when she has another one. She
is not complaining of nausea, vomiting, muscle aches, chills and no backache. For the past 3 to 4
months, she has noticed a tag on her labia. This morning, it seems to be somewhat more enlarged
and painful and would like that evaluated. There are no other complaints or symptomatology.
PAST MEDICAL HISTORY: Significant for frequent UTIs. She has had 4 in the last year. The last
one was in November. She is status post uterine endometrial ablation, and her last menstrual
period was light and approximately 2 weeks ago. She has had frequent labial tags; the last one,
she was cutting off with the knife on her own but has opted not to do that anymore.
CURRENT MEDICATIONS: None.
ALLERGIES: NONE.
SOCIAL HISTORY: Does not use alcohol, drugs or tobacco products.
REVIEW OF SYSTEMS: As above. Otherwise, noncontributory.
PHYSICAL EXAMINATION:
VITAL SIGNS: Blood pressure 140/88, pulse 80, respirations 18, temperature 98.5 and O₂
saturation 94% on room air.
SKIN: On physical examination, skin is pale, warm and dry. There was a small thrombosed skin
tag on the right labia minora.
CHEST: Clear with good breath sounds.
CARDIAC: Regular rate and rhythm without murmur, gallop or rub.
BACK: There is no CVA tenderness.
ABDOMEN: Soft. Minimal tenderness in the suprapubic area. Bowel sounds are normoactive in all
quadrants. No mass, guarding, rigidity or rebound tenderness.
PELVIC: Normal female external genitalia with a skin tag as described above. Her bimanual exam
was negative. There are no adnexal masses and cervix is closed.
INTERVENTION: Urinalysis was obtained which shows specific gravity 1.020, pH 5, white cells
are too numerous to count, 3+ bacteria, small leukocytes. Culture was sent. Skin tag was treated
with pursestring suture at the base of the stalk, which has been used per the patient in the past. At
this time, she will be discharged to home. She is to start on Bactrim DS one b.i.d. She is on
Pyridium 200 mg t.i.d. She is to increase her fluid intake, finish the antibiotics, have her urine
rechecked and have the tag rechecked at that time if it has not avulsed itself. The patient was
discharged to home.
DIAGNOSES:
1. Urinary tract infection.
2. Thrombosed skin tag of the labia minora.

In other circumstances, clinical case histories contributed for the contribution operation 231 may be entered via forms in a dedicated software application or in a web browser-based application provided by web server 10. For example, FIG. 3B is a schematic illustration of a screenshot of a form 400 with fields 410 for entering data in an electronic medical record system. For example, the various fields 410 may correspond to form elements (or text entry boxes) for entering a “Chief Complaint/History of Present Illness,” “Allergies/Conditions/Past Medical History/Family History/Social History,” and “Physical Exam/Review of Symptoms”.

The supplied clinical case history 251, utilization data 252, and disease pathway 253 information is processed to generate structure clinical case data 254, prevalence and correlation frequency data 255, symptoms ontologies 256, predictive models 257, disease models 258, and diagnosis dialogs 259, as described in more detail below.

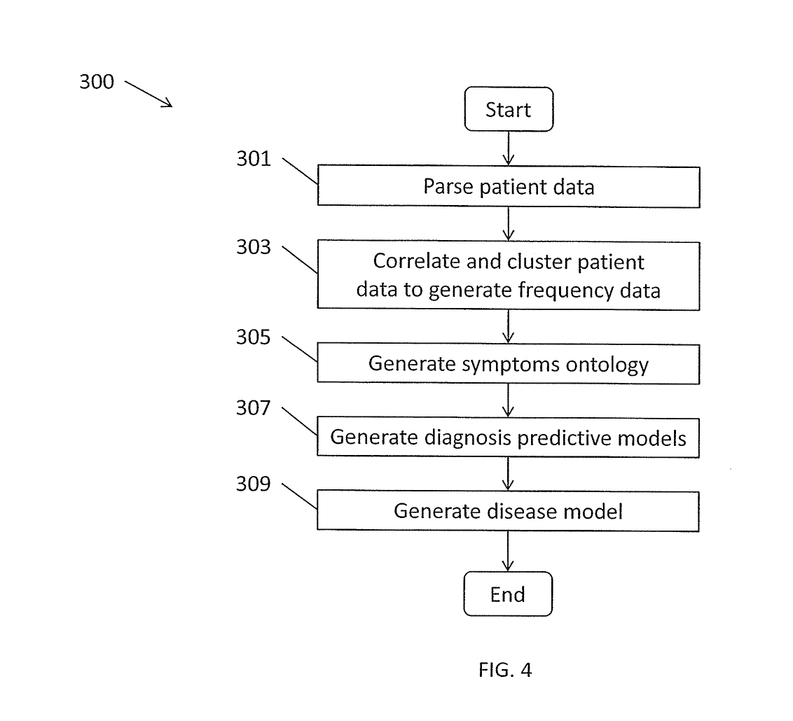

FIG. 4 is a flowchart illustrating a method for processing patient data to generate disease models according to one embodiment of the present invention. In various embodiments of the present invention, the operations shown in this method may be performed by a computing device or computing devices 500 such as the web server 10 and the electronic databases 18. Referring to FIG. 4, patient data 251 (e.g., the aforementioned clinical case history information) supplied to a system according to one embodiment of the present invention may be parsed 301 to generate structured clinical case data 254. The structured clinical case data 254 can then be aggregated with other structured clinical case data and correlated and clustered 303 using cluster analysis to generate prevalence and correlation frequency information 255 to correlate various presenting symptoms with diagnoses. Cluster analysis (or clustering) algorithms are widely known and used to group (or cluster) together objects that are more similar to one another. For example, connectivity clustering leverage distance functions can be used to determine how “close” case objects and their attributes are to each other. In embodiments of the present invention, similar clinical case data can be clustered together, thereby identifying, for example, different clusters of urinary tract infections, each having different symptoms or different underlying causes.

In operation 305, the prevalence and correlation frequency information 255 can then be used to identify key predictive components using “principal component analysis” to generate a symptoms ontology 256, classifying symptoms and demographics into categories of diseases. Principal component analysis is a mathematical procedure that converts a set of observations of possibly correlated variables into a set of values of linearly uncorrelated variables called “principal components.” Here, the symptoms, demographics, and other factors are possibly correlated variables that relate to various diagnoses. By applying principal component analysis, the principal (or predictive) components, that is, the symptoms, demographics, and other factors that best correlate with particular diagnoses can be identified. Continuing the previous example, different types of urinary tract infections may have different symptoms and principal component analysis identifies which of the variables (or combinations thereof) are the most reliable predictors and distinguishers between the various types of urinary tract infection. Leveraging these unique variables, the system can help to distinguish between these various types of urinary tract invention and provide more targeted diagnoses.

In addition, the symptoms ontology 256 can be used with the prevalence and correlation frequency information 255 to generate diagnosis predictive models 257 in operation 307. The resulting symptoms ontology 256 and diagnosis predictive models 257 are used to generate disease models in operation 309.

In some embodiments of the present invention, a general computing device is configured to perform the automatic generation of disease models from a large collection of supplied clinical case data. In other embodiments of the present invention, at least some operations of the method may be performed by dedicated hardware, such as a field programmable gate array (FPGA) and an application specific integrated circuit (ASIC).

The parsing operation 301 generally corresponds to the role of the system in the contribution stage 231 in the lifecycle 230, where data contributed by various actors is initially processed by the system. The correlation and clustering of the patient data in operation 303 generally corresponds to the coupling stage 233 and the consensus stage 235. The generation of diagnosis predictive models 307 corresponds to the component stage 237 in the lifecycle 230, and the generation of disease models in operation 309 corresponds to the content stage 239 in the lifecycle 230.

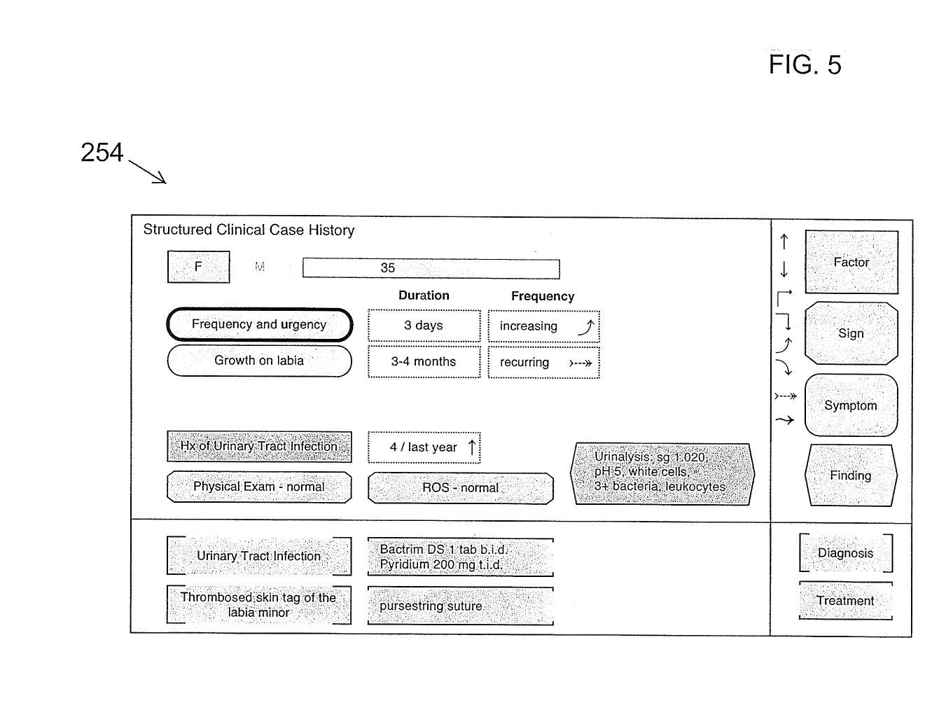

Each of the operations in the method for generating statistical models (one embodiment of which is depicted in FIG. 4) can also be reviewed and edited by an author (such as a medical professional). This review and editing process allows the derived models to be vetted for correctness based on current medical knowledge and the clinical experience of the authors. In addition, authors can fill in gaps or other factors missing from the computer-generated statistical models. FIGS. 5, 6, 7, 8, 9, 10, and 11 are schematic illustrations of user interfaces for editing the data stored in the system and for modifying the statistical models generated as described above.

Referring again to operation 301, the clinical case history data may be parsed to generate structured clinical case data 254 from the freeform text or text entered into a more structured form. FIG. 5 is a schematic illustration of a screenshot of an example of a structured clinical case history according to one embodiment of the present invention. As part of the parsing process, abbreviations, synonyms, and phrases, are parsed into distinct and non-redundant concepts. In addition, measurements associated with symptoms may be identified and extracted from the clinical case history data. For example, measurements of temperature, pulse rate, blood pressure, and O₂ saturation can be identified in accordance with known synonyms and abbreviations used to label these values. The supplied measurements (e.g., 103° F. from “patient had an oral temperature of 103° F.”) can be extracted from the clinical case history data to be supplied in a structured manner in the structured clinical case history.

For example, as seen in FIG. 5, the clinical case history can include information such as the sex and age of the individual, a list of symptoms (“frequency and urgency” and “growth on labia”), the duration and frequency of the symptoms (e.g., 3 days, 3-4 months, increasing, recurring, etc.), a history of prior related medical incidents, lab findings (e.g., urinalysis data), the diagnosis, and the prescribed treatment.

In various embodiments of the present invention, the parsing of the text can be performed using a variety of natural language processing (NLP) techniques to identify the various words within the text and semantic mapping techniques to map the words to clinical concepts.

The parsed structured data may be quickly reviewed by a medical professional, and the data can be easily annotated and edited to correct errors and to add information. In addition, the organization of data in the display can be standardized, allowing medical professionals to quickly and easily understand the case history without having to read and understand the freeform notes originally entered. New factors, signs, symptoms, and findings can be automatically imported from external data sources and/or manually entered (e.g., using a drag and drop interface).

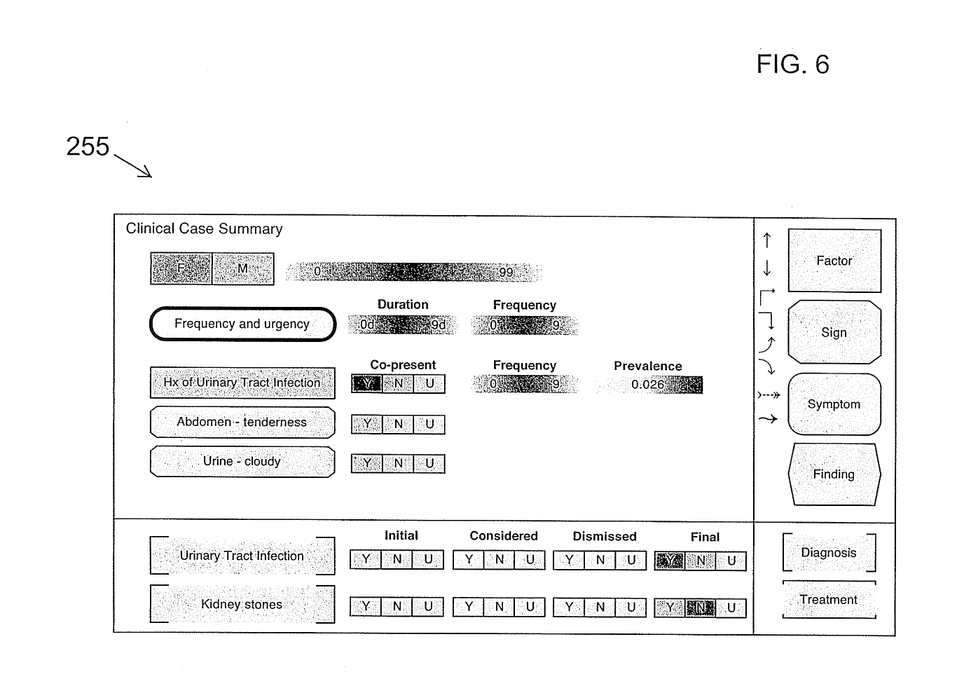

The data from the various sources can then be coupled together to generate prevalence and correlation frequency data 255 using, e.g., mathematical clustering (“cluster analysis” and “principal component analysis”), as described in more detail above with respect to operations 303 and 305. FIG. 6 is a schematic illustration of a screenshot of a clinical case summary generated from the prevalence and correlation frequency data 255 according to one embodiment of the present invention. For example, cases having the same or similar sets of observed signs, symptoms, and other factors from multiple sources can be aggregated to tally the appearances and characteristics of those symptoms. The display indicates the strength of a correlation between chief complaints, signs, symptoms, and other factors using, for example, differing colors or shadings. In addition, information regarding the prevalence of particular factors, signs and symptoms among other members of the group (e.g., other patients presenting similar symptoms or with similar diagnoses) can also be displayed.

Using the interface shown in FIG. 6, according to one embodiment of the present invention, a user (e.g., a medical professional) can view a summary of cases based on matching chief complaints or associated factors. The user can lock-in, add, or exclude factors based on whether those factors appear pertinent (e.g., based on the strength of the correlations of those factors or as revealed by the cluster analysis of the data). In addition, factors and diagnoses may be color coded or shaded differently to represent frequencies and/or distributions of values.

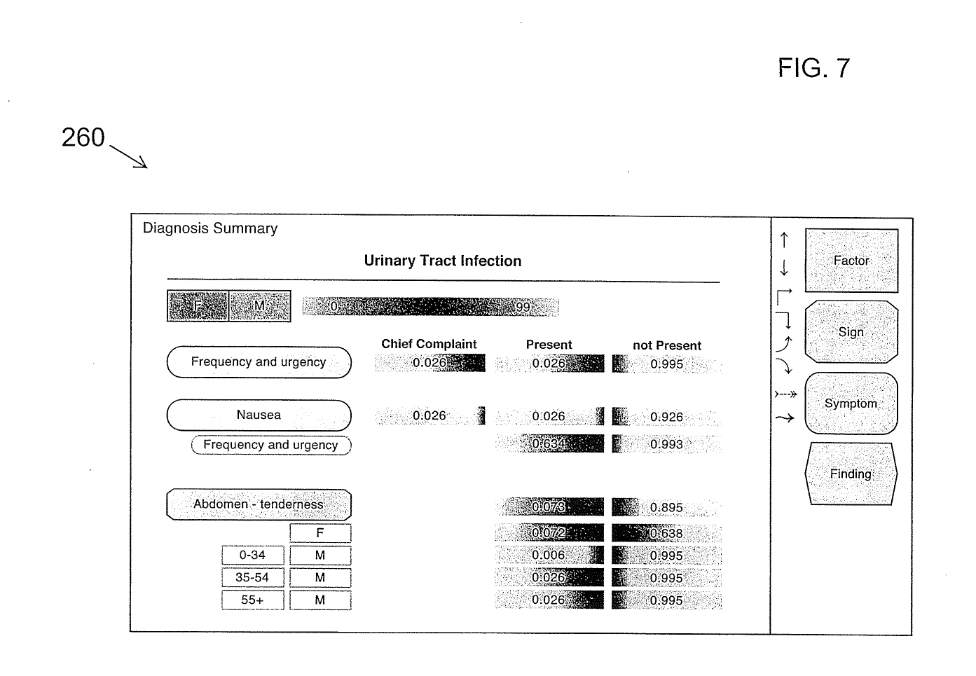

FIG. 7 is a schematic illustration of a screenshot of an interface for viewing and editing a diagnosis summary 260 according to one embodiment of the present invention. This view is a pivot from the above-described clinical case summary view in the sense that the clinical case summary view is organized by related signs, symptoms, and factors and shows diagnoses associated with those signs, symptoms, and factors while the diagnosis summary view is organized by diagnosis and shows the frequency with which particular signs, symptoms, and other factors are correlated with those diagnoses. For example, as seen in the schematic screenshot shown in FIG. 7 according to one embodiment of the present invention, urinary tract infections are shown as more strongly correlated with females in a particular age range. In addition, as seen in FIG. 7, the fraction of cases in which various symptoms were present or absent and in which symptoms were the chief complaint are also shown. This data can also be broken down by demographics such as age range and sex.

By identifying strong correlations (e.g., correlations having a metric exceeding a threshold) between particular signs, symptoms, lab results and correctly identified diseases, key predictive components of the clinical observations can be identified and used to create a symptoms ontology 256, classifying symptoms and demographics into categories of diseases. Systems and methods of the present invention identify the correlations and set initial weights to specify relevance and value, which may be later adjusted and edited by an author who interprets the correlations identified by the system.

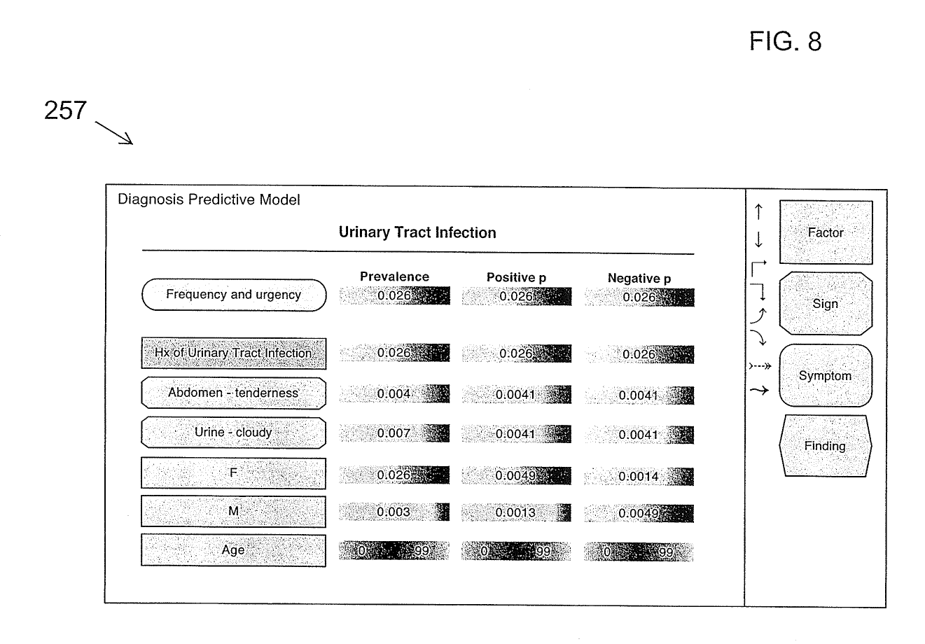

FIG. 8 is a schematic illustration of a screenshot of an interface for viewing and editing a diagnosis predictive model 257 according to one embodiment of the present invention. The frequency values can be used to estimate predictive values, and the predictive values can be directly manipulated by the interface. Factors can also be added and removed, and different snapshots of the disease (e.g., corresponding to different stages or severities of the disease) can also be saved.

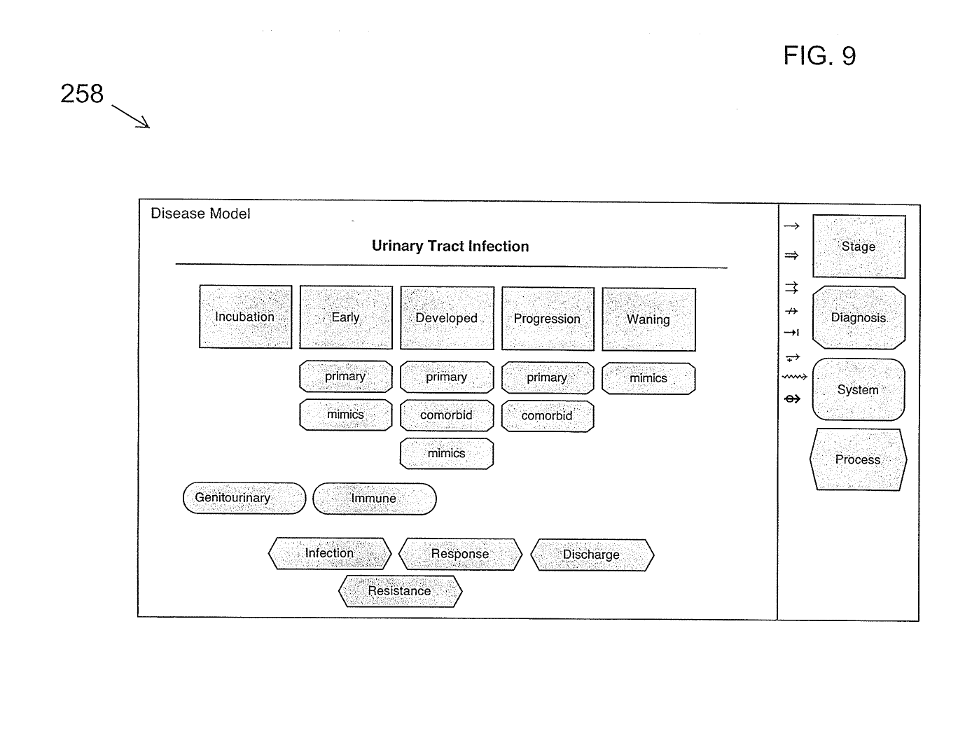

The multiple diagnosis predictive models corresponding to different stages over the course or pathway of the disease (e.g., incubation, early, developed, progression, and waning) for particular demographics (e.g., male, female, young, old, history, allergies, and combinations thereof) can be combined to develop a disease model 258. FIG. 9 is a schematic illustration of a screenshot of an interface for viewing and editing a disease model according to one embodiment of the present invention. Diseases can also be linked together to track disease for comorbidity or metastasis. The disease model 258 is a way to aggregate together various diagnosis models, each diagnosis model being created and validated by an expert and which can be highly specialized for a particular demographic (e.g., age, sex, ethnicity), geographic region, stage of disease. Individual clinicians can contribute to their particular diagnosis model particular to the types of patients they typically encounter. Individual clusters or niches of the population that have their own highly segmented unique characteristics for their particular diseases may have their own separate diagnosis model.

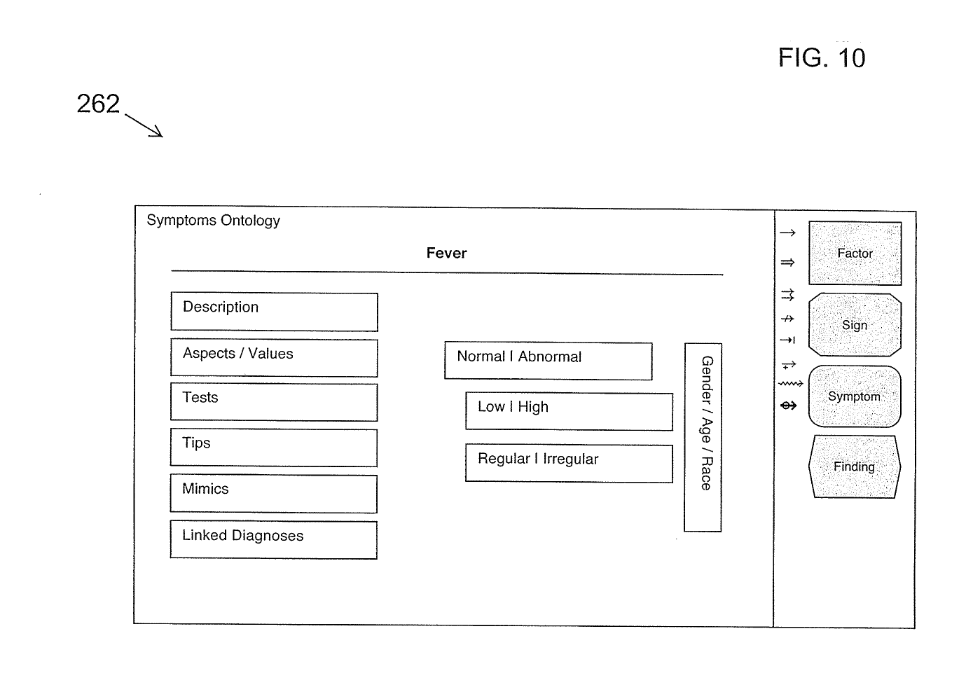

FIG. 10 is a schematic illustration of a screenshot of a user interface 262 for viewing and editing symptoms ontology according to one embodiment of the present invention. In more detail, FIG. 10 illustrates a symptoms ontology for fever, with links to information such as a description of the disease, aspects and values associated with the disease, tests that can be run and the significance of test results, tips for dealing with the disease, links to mimics (e.g., other similar diseases), and links to other diagnoses. A symptoms ontology according to embodiments of the present invention provide an advantage over the prior art by consistently mapping synonyms and alternate phrasings to the same concept (e.g., “running a temperature” and “hyperpyrexia”) and consistently and robustly mapping concepts to observed values (e.g., a high fever for adults is a temperature>103 F whereas a high fever for infants and the elderly is >100 F), thereby reducing redundancies and ambiguities in disease and symptom classifications. Table 2 is an example of a symptoms ontology for the genitourinary system.

TABLE 2
NHAMCS Reason For Visit Classification -
GENITOURINARY SYSTEM

1640.0 Abnormalities of urine
1640.1 Blood in urine (hematuria)
1640.2 Pus in urine
1640.3 Unusual color or ordor
1645.0 Frequency and urgency of urination
1645.1 Excessive urination, night (nocturia)
1650.0 Painful urination [includes: burning, discomfort]
1655.0 Incontinence of urine (enuresis)
1655.1 Involuntary urination, can't hold urine, dribbling, wetting pants
1660.0 Other urinary dysfunctions [includes: trouble going, urinary
pressure, weak stream]
1660.1 Retention of urine [includes: can't urinate]
1660.2 Hesitancy [includes: difficulty in starting stream]
1660.3 Large volume [includes: polyuria]
1660.4 Small volume
1665.0 Symptoms of bladder [includes: bladder trouble]
1665.1 Pain
1665.2 Infection
1665.3 Mass
1670.0 Symptoms of the kidneys [includes: kidney trouble]
1675.0 Urinary tract infection, NOS [includes: genitourinary infection,
urine infection]
1680.0 Other symptoms referable to urinary tract [includes: passed
stones, urethral bleeding, urinary irritation] [excludes: kidney stones
or bladder stones (2705.0)]

Currently, the classification of symptoms (e.g., back pain, lower back, upper back, type of pain) classifications are dealt with on an organization system that makes sense to a medical professional, but may not make sense to a lay person (e.g., too much terminology). This is a “complaints” ontology which attempts to understand how people experience and report their symptoms and to create logical bridges between how a patient describes their symptoms and how these diseases are mapped out by the medical profession. Other systems may attempt to guide lay users to currently medically standard terms, but lay users may not fully understand the meanings of these individual types. As such, a community created system for creating guides to help patients answer the right question, e.g., simple physical tests to perform or “tips” on how to report medically useful information.

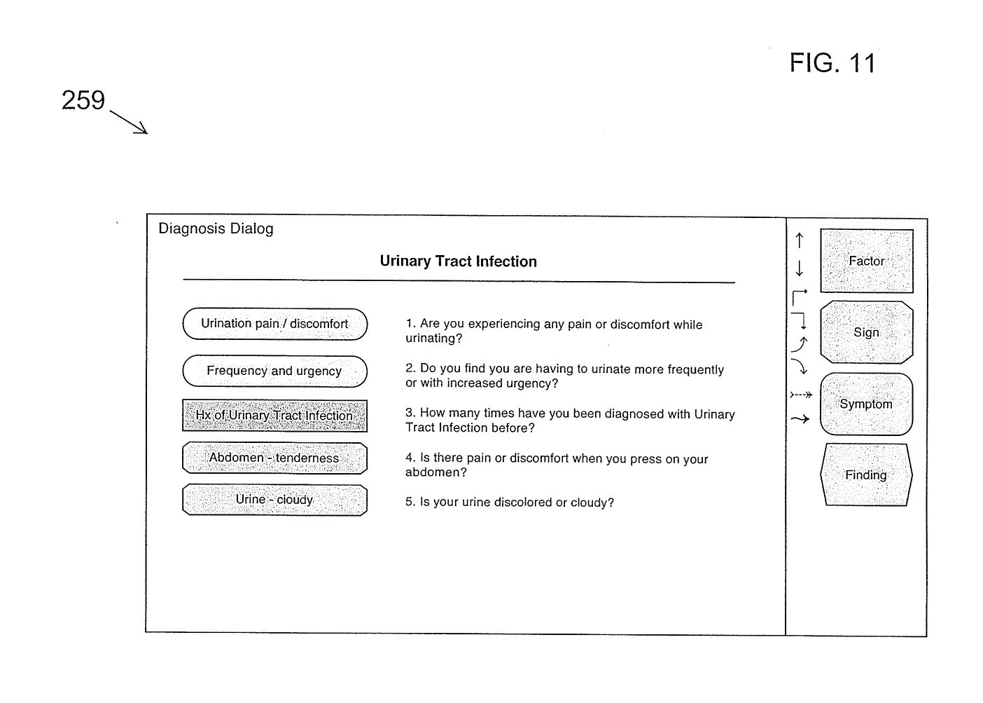

A diagnosis dialog 259 (e.g., a wizard) can be generated using the disease models, the diagnosis predictive models, and the symptom ontology in which specific questions are sequentially asked and lab tests may be suggested based on the predictive abilities of particular tests (e.g., tests associated with more strongly correlated factors would be more clearly indicative of particular diseases). FIG. 11 is a schematic illustration of a screenshot of an interface for viewing and editing a diagnosis dialog 259 for diagnosing a patient according to one embodiment of the present invention. The diagnosis dialog may determine a sequence of factors that are most predictive and constructions questions to collect pertinent aspects of pertinent factors. The phrasing of the questions and the types of questions asked may be adjusted based on the consumer using the dialog (e.g., whether the consumer is a medical professional or a lay person) and the demographics (e.g., by ruling out or weighing the likelihood of some potential diseases based on sex or age).

For example, when diagnosing whether an individual has a urinary tract infection, a lay person may be asked: “1. Are you experiencing any pain or discomfort while urinating?” “2. Do you find you are having to urinate more frequently or with increased urgency?” “3. How many times have you been diagnosed with Urinary Tract Infection before?” “4. Is there pain or discomfort when you press on your abdomen?” and “5. Is your urine discolored or cloudy?” in that order. In some embodiments, the order in which the questions are asked may also be performed in a way that optimized the predictiveness of the tests and questions while minimizing the invasiveness of the test performed. Questions that have already been answered or that would have no predictive value given already known information (e.g., answers to previous questions) would not be asked.

Data viewed or entered at any given stage may be modified (e.g., by adding and removing signs, symptoms, and factors) by medical professionals based on their observations. These changes may be reviewed or aggregated with other entries to allow medical professionals to collaboratively refine the quality of the information stored in the system as medical professionals verify or identify problems with the stored information.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method for authoring clinical diagnosis data, the method comprising:
parsing, on a processing device, clinical data regarding components and diagnoses of diseases, the components comprising at least one of signs, symptoms, or factors for generating structured clinical data;
correlating, on the processing device, the structured clinical data based on at least one of the components;
determining, on the processing device, clusters of the components that are related to the diseases;
identifying, using principal component analysis on the processing device, one or more predictive components of the clusters of the components related to the diseases for generating a diagnosis predictive model; and
generating, on the processing device, a disease model based on the diagnosis predictive model, the disease model being for diagnosing a patient in accordance with the identified one or more predictive components.

2. The method of claim 1, wherein the parsing the clinical data comprises:
identifying a measurement associated with a symptom using semantic mapping; and
extracting the identified measurement.

3. The method of claim 2, wherein the measurement comprises a temperature, a pulse rate, a blood pressure, or an O₂ saturation.

4. The method of claim 1, further comprising:
displaying the structured clinical data in a user interface;
receiving a request to modify the structured clinical data via the user interface; and
modifying the structured clinical data in accordance with the request.

5. The method of claim 1, further comprising:
displaying the diagnosis predictive model in a user interface, the display including an indication of a strength of correlation between signs, symptoms, and factors;
receiving a request to modify the diagnosis predictive model; and
modifying the diagnosis predictive model in accordance with the modification.

6. The method of claim 5, wherein the request comprises one of adding, excluding, and locking in a sign, a symptom, or a factor.

7. The method of claim 1, wherein the identifying one or more principal components comprises performing principal component analysis on the structured data.

8. The method of claim 1, further comprising displaying a diagnosis summary, wherein the diagnosis summary displays a frequency with which particular signs, symptoms, and factors are correlated with a diagnosis.

9. The method of claim 1, further comprising computing, on the processing device, a symptoms ontology, the symptoms ontology relating symptoms and alternate phrasings to concepts and mapping the concepts to observed values.

10. A system for authoring clinical diagnosis data, the system comprising a processing device comprising a processor and a memory storing instructions, the instructions configuring the processor to:
parse clinical data regarding components and diagnoses of diseases, the components comprising at least one of signs, symptoms, or factors, for generating structured clinical data;
correlate the clinical data based on at least one of the components;
determine clusters of the components that are related to the diseases;
identify, using principal component analysis, one or more predictive components of the clusters of the components related to the diseases for generating a diagnosis predictive model; and
generate a disease model based on the diagnosis predictive model, the disease model being for diagnosing a patient in accordance with the identified one or more predictive components.

11. The system of claim 10, wherein the instructions configure the processor to parse clinical data by:
identifying a measurement associated with a symptom using semantic mapping; and
extracting the identified measurement.

12. The system of claim 11, wherein the measurement comprises a temperature, a pulse rate, a blood pressure, or an O₂ saturation.

13. The system of claim 10, wherein the instructions further configure the processor to:
display the structured clinical data in a user interface;
receive a request to modify the structured clinical data via the user interface; and
modify the structured clinical data in accordance with the request.

14. The system of claim 10, wherein the instructions further configure the processor to:
display the diagnosis predictive model in a user interface, the display including an indication of a strength of correlation between signs, symptoms, and factors;
receive a request to modify the diagnosis predictive model; and
modify the diagnosis predictive model in accordance with the modification.

15. The system of claim 14, wherein the request comprises one of adding, excluding, and locking in a sign, a symptom, or a factor.

16. The system of claim 10, wherein the instructions further configure the processor to identify one or more principal components by performing principal component analysis on the structured clinical data.

17. The system of claim 10, wherein the instructions further configure the processor to display a diagnosis summary, wherein the diagnosis summary displays a frequency with which particular signs, symptoms, and factors are correlated with a diagnosis.

18. The system of claim 10, wherein the instructions further configure the processor to compute a symptoms ontology, the symptoms ontology relating symptoms and alternate phrasings to concepts and mapping the concepts to observed values.
